(19) United States
(12) Patent Application Publication
(10) Pub. No.: US 2002/0105262 A1
(43) Pub. Date: Aug. 8, 2002

(54) Slim cathode ray tube and method of fabricating the same

(75) Inventor: Steven Kim, Harrington Park, NJ (US)

Correspondence Address: MORGAN LEWIS & BOCKIUS LLP, 1111 PENNSYLVANIA AVENUE NW, WASHINGTON, DC, 20004, US

(73) Assignee: Plasmion Corporation

(21) Appl. No.: 10/042,172

(22) Filed: Jan. 11, 2002

Related U.S. Application Data
(60) Provisional application No. 60/265,894, filed on Feb. 5, 2001.

(51) Int. Cl. H01J 1/62

(52) U.S. Cl. 313/495; 313/310

(57) ABSTRACT

The specification and drawings describe and show embodiments of the present invention in the form of a slim cathode ray tube and a method of fabricating the same. More specifically, a slim cathode ray tube includes a vacuum tight envelope having front and back panels, the front panel including a fluorescent screen and a shadow mask thereon, at least one emitter plate on the back panel and having a plurality of planar electron emitters each generating an electron beam onto the fluorescent screen through the shadow mask, wherein the planar electron emitters have an electron emission surface that has a form of a conical shape, and an acceleration grid over the planar electron emitters and accelerating the electron beam and directing the accelerated electron beam onto the fluorescent screen. It is emphasized that this abstract is provided to comply with the rule requiring an abstract that will allow a searcher or other reader to quickly ascertain the subject matter of the technical disclosure. It is submitted with the understanding that it will not be used to interpret or limit the scope or meaning of the claims.

This application claims the benefit of a provisional application, entitled, “Method of Making Slim CRT,” which was filed on Feb. 5, 2001, and assigned Provisional Application Number 60/265,894, which is hereby incorporated by reference.

### BACKGROUND OF THE INVENTION

1. Field of the Invention

The present invention relates to a display device, and more particularly, to a slim cathode ray tube and a method of fabricating the same. Although the present invention is suitable for a wide scope of applications, it is particularly suitable for reducing a lateral dimension of the cathode ray tube with a relatively low cost.

2. Discussion of the Related Art

Among display devices, a conventional cathode ray tube (CRT) has many beneficial features, such as a simple fabrication process, high brightness, a high dynamic range, excellent color realization, a wide viewing angle, and a high resolution, etc.

The conventional CRT generally includes a vacuum tight envelope (glass bulb) provided with a panel arranged to the front side on which a fluorescent screen is formed. At the rear side, there is a slender neck portion at which an electron gun is mounted. Also, there is a funnel tail portion connecting the panel and the neck portion. Due to the funnel tail portion, the conventional CRT has the most fatal disadvantage of a huge nonlinear increase in volume or weight as a size of the screen increases.

### SUMMARY OF THE INVENTION

Accordingly, the present invention is directed to a slim cathode ray tube and a method of fabricating the same that substantially obviates one or more of problems due to limitations and disadvantages of the related art.

Another object of the present invention is to provide a slim cathode ray tube and a method of fabricating the same that reduces a lateral dimension of the cathode ray tube with a relatively low cost.

Another object of the present invention is to provide a slim cathode ray tube and a method of fabricating the same that enables a reliable operation and a long electron beam trajectory for the use of CRT applications.

Additional features and advantages of the invention will be set forth in the description that follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a slim cathode ray tube includes a vacuum tight envelope having front and back panels, the front panel including a fluorescent screen and a shadow mask thereon, at least one emitter plate in the vacuum tight electrode and having a plurality of planar electron emitters each generating an electron beam onto the fluorescent screen through the shadow mask, wherein the planar electron emitters have an emission surface that has a form of a conical shape, and an acceleration grid over the planar electron emitters and accelerating the electron beam and directing the accelerated electron beam onto the fluorescent screen.

In another aspect of the present invention, a method of fabricating a slim cathode ray tube includes preparing a vacuum tight envelope having front and back panels, forming a fluorescent screen and a shadow mask on the front panel, forming an acceleration grid below the shadow mask to accelerate the electron beam and direct the accelerated electron beam onto the fluorescent screen, and forming at least one emitter plate in the vacuum tight envelope and having a plurality of planar electron emitters to generate an electron beam onto the fluorescent screen through the shadow mask, wherein the planar electron emitters have an emitting surface that has a form of a conical shape.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIGS. 1A and 1B are a schematic cross-sectional view of a surface of a planar electron emitter illustrating a boundary between a cesiated diamond-like carbon layer and a metallic layer and a schematic cross-sectional view of the portion “A” according to the present invention, respectively;

FIGS. 2A to 2D are cross-sectional views illustrating fabricating process steps for the planar electron emitter according to the present invention;

FIG. 3 is a schematic cross-sectional view of a slim cathode ray tube according to the present invention;

FIGS. 4A and 4B are a partial schematic cross-sectional view illustrating the planar electron emitter and the acceleration grid of FIG. 3 and a top view of the portion “B” of FIG. 4A, respectively; and

FIG. 5 is a schematic view illustrating that the planar electron emitter is formed of a plurality of emitter plates.

### DETAILED DESCRIPTION OF THE ILLUSTRATED EMBODIMENTS

Reference will now be made in detail to the illustrated embodiments of the present invention, examples of which are illustrated in the accompanying drawings. Wherever possible, the same reference numbers will be used throughout the drawings to refer to the same or like parts.

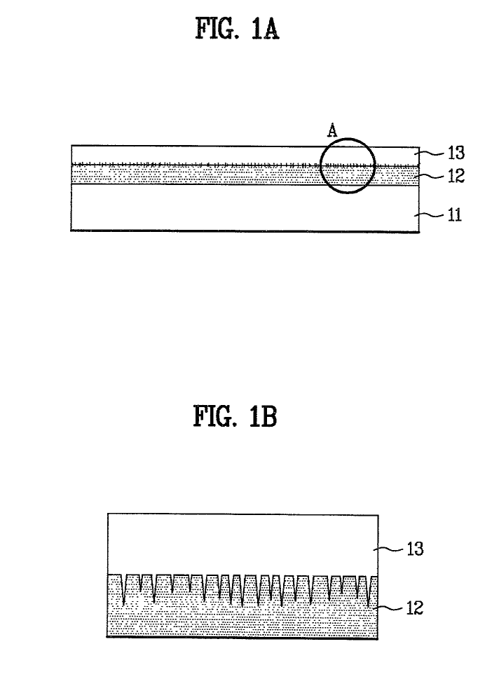

Initially referring to FIG. 1, an interface between a metallic layer 13 and a cesiated diamond-like carbon (DLC) layer 12 on a substrate 11 is schematically illustrated. The cesiated DLC layer 12 is a DLC layer having cesium dispersed therein in either atomic form, or compounded. The cesium at the surface enhances electron emission from the DLC layer. The cesiated DLC layer 12 is formed on the substrate 11 by using a similar methodology that was disclosed in U.S. Pat. No. 5,852,303, which is hereby incorporated by reference.

For example, a glass substrate may be used in the present invention. However, other substrates, such as molybdenum, silicon, and titanium dioxide, etc., may also be suitable for the present invention.

After depositing the cesiated DLC layer 12, the metallic layer 13 is formed on the cesiated DLC layer 12. A refractory metal, such as molybdenum and tungsten, may be suitable for the metallic layer 13. The metallic layer 13 is deposited on the cesiated DLC layer by using a direct metal ion beam technology. In this process, a voltage of about 300 to 1000 V is used for this application. Since highly energized metal ions collide onto the DLC layer 12, some of the metallic ions penetrate into the DLC layer 12. Thus, a spike is formed around the surface. Due to such a spike, the adhesion between the cesiated DLC layer 12 and the metallic layer 13 becomes strong.

A partial view of the interface between the cesiated DLC layer 12 and the metallic layer 13, which is identified as the portion “A” of FIG. 1A, is schematically illustrated in FIG. 1B.

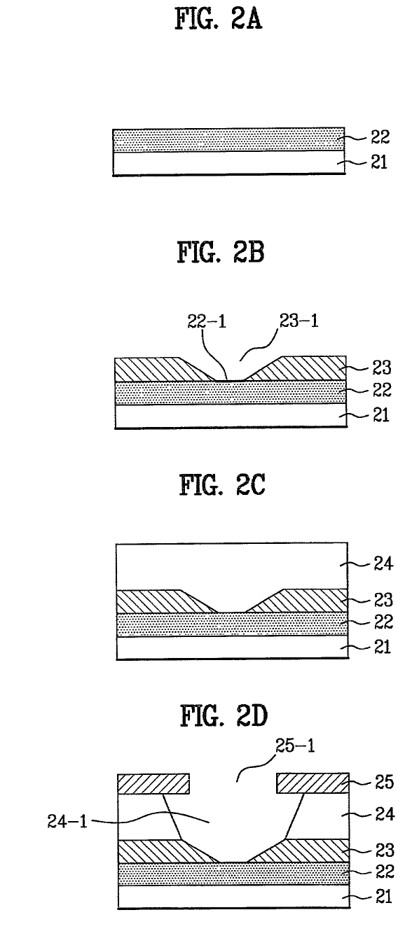

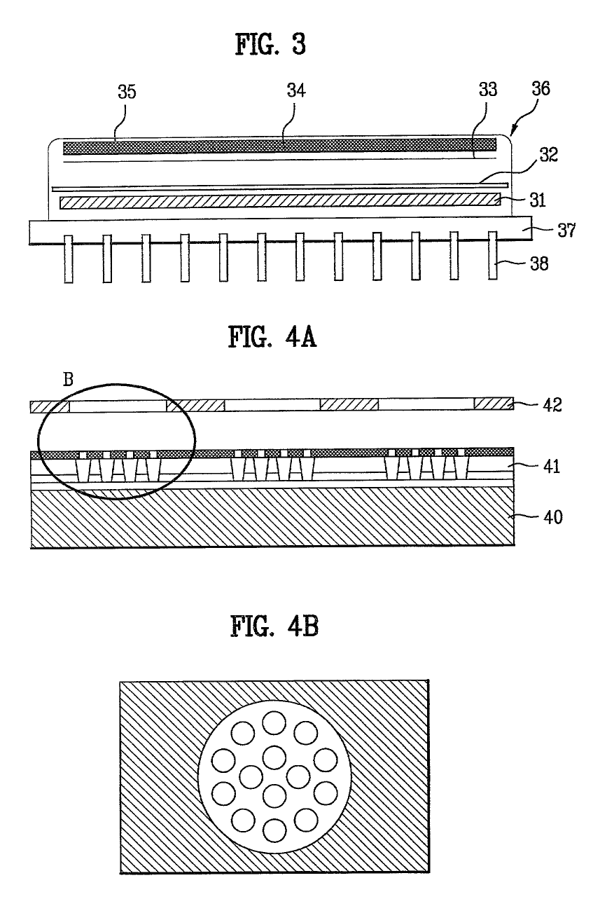

FIGS. 2A to 2D are schematic cross-sectional views illustrating the fabrication process steps for a planar electron emitter in the present invention.

After cleaning a substrate 21, a cesiated DLC layer 22 is formed thereon as shown in FIG. 2A. The surface of the cesiated DLC layer 22 is then cleaned.

Thereafter, a first metallic layer 23 such as a refractory metal (for example, molybdenum and tungsten, etc.) is deposited on the cesiated DLC layer 22 by using a direct metal ion beam technology as shown in FIG. 2B. Subsequently, the first metallic layer 23 is patterned by photolithography to form a first hollow 23-1. The first hollow 23-2 may have a frustoconical shape. As shown in FIG. 2B, a portion of the cesiated DLC layer 22-1 is exposed for a planar emission surface. The patterned first metallic layer 23 acts as a control electrode, so that a control voltage is applied to control an electron beam emitted from the planar emission surface 22-1.

In FIG. 2C, a dielectric layer 24 such as SiO₂ is formed on the entire surface including the patterned first metallic layer 23. Thus, the entire surface is planarized by the dielectric layer 24.

A second metallic layer 25 is formed on the dielectric layer 24 and patterned by photolithography, thereby forming a third hollow 25-1 as shown in FIG. 2D. The third hollow 25-1 may have a cylindrical shape. Using a dielectric mask, the second metallic layer 25 is then patterned to form a second hollow 24-1 by using series of photolithographic processes. The second patterned metallic layer 25 acts as a gate electrode, so that a gate bias voltage is applied.

Since the first hollow 23-1 has a frustoconical shape, it has two different top and bottom diameters. The bottom diameter is an opening for the planar emission surface 22-1. The top diameter is connected to the second hollow 24-1. The third hollow 25-1 is formed in the second metallic layer 25, as described above. For a better electron emission efficiency, the area of the planar emission surface may have to be smaller than both the top diameter of the first hollow 23-1 and the diameter for the third hollow 25-1. Also, the top diameter of the first hollow 23-1 may have to be greater than the diameter for the third hollow 25-1.

FIG. 3 illustrates a schematic cross-sectional view of a slim cathode ray tube according to the present invention.

As shown in FIG. 3, the slim cathode ray tube of the present invention includes a planar electron emitter 31, an acceleration grid 32, a shadow mask 33, a fluorescent screen 34, an vacuum tight envelope 36 having a front panel 34 and a back panel 37, and a plurality of studs 38 for supporting the back panel 37.

More specifically, the planar electron emitter 31 is positioned in the vacuum tight envelope 36 for generating an electron beam onto the fluorescent screen 34. A phosphor layer is coated on the screen 34. Thus, when an electron beam is landed on the screen, light rays are generated in response to the landing.

The acceleration grid 32 is located over the planar electron emitter 31 for accelerating the electron beam and directing the accelerated electron beam onto the fluorescent screen 34. A voltage is applied to the acceleration grid to accelerate the electron beam. For example, the applied grid voltage is in the range of about 20 to 40 kV.

Unlike the field emission devices having a short focal length, the planar electron emitter of the present invention has a long focal length between the emission surface and the fluorescent screen. For example, a focal length is in the range of about 1 to 5 cm, which is particularly suitable for CRT applications. Thus, the planar electron emitter of the present invention can be used with a front panel of the conventional CRT. An acceleration grid 32 is located between the emission surface and the fluorescent screen 35.

FIG. 4A is a partial schematic cross-sectional view illustrating the planar electron emitter and the acceleration grid as shown in FIG. 3. FIG. 4B is a top view of the portion “B” of FIG. 4A.

A bundle of the planar electron emitters 41 corresponding to each aperture of the acceleration grid may be used in the present invention, as shown in FIGS. 4A and 4B. The aperture of the acceleration grid 42 is targeted to each pixel. Thus, a gray scale of the image may also be controlled in the present invention by adjusting an applied voltage to each planar electron emitter. Moreover, uniformity of the emitter may also be compensated.

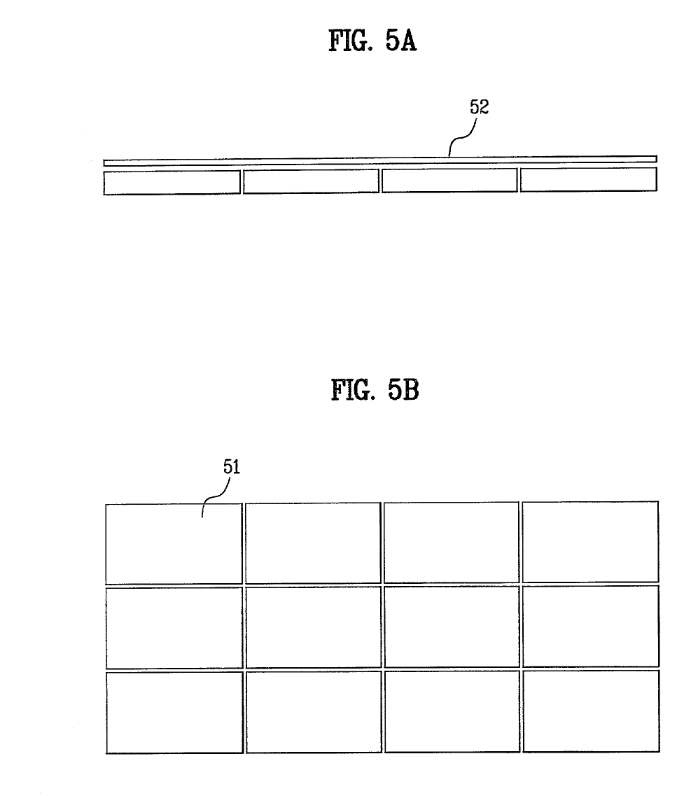

FIGS. 5A and 5B are a schematic view and a bottom view respectively illustrating that a planar electron emitter is formed of a plurality of emitter plates. Each emitter plate 51 may contain a bundle of the planar electron emitters, as shown in FIGS. 4A and 4B. Thus, the emitter plates are formed of a mosaic pattern. If one of the planar electron emitters is malfunctioned, it is readily replaceable with another emitter plate. Also, a small sized emitter would not cause any trim edge problem since it is blended upon being projected to the fluorescent screen. Using the emitter plate, a slim cathode ray tube having a screen size of 19″ to 40″ may be fabricated using a thin film process under a vacuum condition.

It will be apparent to those skilled in the art that various modifications and variations can be made in the slim cathode ray tube and the method of fabricating the same of the present invention without departing from the spirit or scope of the inventions. Thus, it is intended that the present invention covers the modifications and variations of this invention provided they come within the scope of the appended claims and their equivalents.

What is claimed is:

1. A slim cathode ray tube comprising:
a vacuum tight envelope having front and back panels, the front panel including a fluorescent screen and a shadow mask thereon;
at least one emitter plate in the vacuum tight envelope and having a plurality of planar electron emitters each generating an electron beam onto the fluorescent screen through the shadow mask, wherein the planar electron emitters have an emission surface that has a form of a conical shape; and
an acceleration grid over the planar electron emitters and accelerating the electron beam and directing the accelerated electron beam onto the fluorescent screen.

2. The slim cathode ray tube according to claim 1, further comprising a plurality of studs supporting the back panel.

3. The slim cathode ray tube according to claim 1, wherein the planar electron emitter includes:
a substrate;
a cesiated diamond-like carbon layer on the substrate and having an emission surface;
a first metallic layer on the diamond-like carbon layer and having a first hollow substantially on the center thereon;
a dielectric layer on the first metallic layer and having a second hollow in the vicinity of the first hollow; and
a second metallic layer on the dielectric layer and having a third hollow over the first and second hollows.

4. The slim cathode ray tube according to claim 3, wherein the first, second, and third hollows are frustoconical, segmented ball, and cylindrical shapes, respectively.

5. The slim cathode ray tube according to claim 3, wherein the first hollow has first and second diameters, and the third hollow has a third diameter, wherein the second diameter is the greatest and the third diameter is the shortest among the three diameters.

6. The slim cathode ray tube according to claim 1, wherein the cesiated diamond-like carbon layer includes cesium therein.

7. The slim cathode ray tube according to claim 1, wherein the first and second metallic layers are formed of a refractory metal.

8. The slim cathode ray tube according to claim 1, wherein the cesiated diamond-like carbon layer includes a plurality of metallic ions therein as a spike form.

9. The slim cathode ray tube according to claim 1, wherein the planar electron emitters form an electron emitter array having a plurality of the planar electron emitters corresponding to each hole of the acceleration grid.

10. The slim cathode ray tube according to claim 1, wherein the dielectric layer is formed of SiO₂.

11. The slim cathode ray tube according to claim 1, wherein the first and second metallic layers act as a control electrode and a gate electrode, respectively.

12. The slim cathode ray tube according to claim 11, wherein the control electrode is applied with a control voltage high enough to control the electron beam.

13. The slim cathode ray tube according to claim 11, wherein the gate electrode is applied with a gate bias voltage.

14. The slim cathode ray tube according to claim 1, wherein the acceleration grid is applied with a voltage high enough to accelerate the electron beam.

15. The slim cathode ray tube according to claim 14, wherein the applied voltage is in the range of about 20 to 40 kV.

16. The slim cathode ray tube according to claim 1, wherein the emission surface is separated from the fluorescent screen by about 1 to 5 cm.

17. A method of fabricating a slim cathode ray tube, comprising:
preparing a vacuum tight envelope having front and back panels;
forming a fluorescent screen and a shadow mask on the front panel;
forming an acceleration grid below the shadow mask to accelerate the electron beam and direct the accelerated electron beam onto the fluorescent screen; and
forming at least one emitter plate in the vacuum tight envelope and having a plurality of planar electron emitters to generate an electron beam onto the fluorescent screen through the shadow mask, wherein the planar electron emitters have an emitting surface that has a form of a conical shape.

18. The method according to claim 16, wherein the forming at least one emitter plate includes:
forming a cesiated diamond-like carbon layer on the substrate to have an emission surface;
forming a first metallic layer on the diamond-like carbon layer, having a first hollow substantially on the center thereon;
forming a dielectric layer on the first metallic layer, having a second hollow in the vicinity of the first hollow; and
forming a second metallic layer on the dielectric layer and having a third hollow over the first and second hollows.

19. The slim cathode ray tube according to claim 17, wherein the first, second, and third hollows are frustoconical, segmented ball, and cylindrical shapes, respectively.

20. The slim cathode ray tube according to claim 17, wherein the first hollow has first and second diameters, and the third hollow has a third diameter, wherein the second diameter is the greatest and the third diameter is the shortest among the three diameters.

21. The slim cathode ray tube according to claim 17, wherein the cesiated diamond-like carbon layer includes cesium therein.

22. The slim cathode ray tube according to claim 17, wherein the first and second metallic layers are formed of a refractory metal.
